(19) United States
(12) Patent Application Publication
(10) Pub. No.: US 2007/0292233 A1
(43) Pub. Date: Dec. 20, 2007

(54) LOCKING SHEAR NUT

(76) Inventor: Stephane D'Aoust, Ottawa (CA)

Correspondence Address: ECKERT SEAMANS CHERIN & MELLOTT, 600 GRANT STREET, 44TH FLOOR, PITTSBURGH, PA, 15219, US

(21) Appl. No.: 11/550,013

(22) Filed: Oct. 17, 2006

(30) Foreign Application Priority Data
Jun. 14, 2006 (CA) CA 2,550,553

(51) Int. Cl. F16B 39/28

(52) U.S. Cl. 411/291

(57) ABSTRACT

A locking nut comprising at least two nut portions and at least one frangible bridging portion and a method of making a locking nut. The nut portions are made from a single nut. Each nut portion has an outer gripping surface and a centrally disposed threaded aperture for receiving and engaging a screw. The bridging portion is integral with the nut portions and is disposed to a side of the aperture adjacent to the gripping surface. The nut portions are disposed on either side of the bridging portion so that the apertures are axially aligned, the threads are aligned and a space is defined between opposing faces of the nut portions. By applying torque to one of the nut portions relative to the other nut portion, the bridging portion is sheared and opposing faces of the nut portions are brought into contact and the nut portions are locked in place.

### FIELD OF THE INVENTION

The present invention relates to locking nuts, also known as jam nuts or lock nuts.

### BACKGROUND OF THE INVENTION

U.S. Pat. No. 2,394,812 discloses a lock nut comprising two superimposed nuts which are joined by a plurality of bonds of solder. The lock nut is threaded onto a bolt until a lower one of the nuts is tightened against the working surface. Torque is applied to the upper one of the nuts to shear the bonds of solder and lock the nuts in place. The solder will tend to be extruded as opposing faces of the two nuts come into contact. The extruded portion of the solder can interfere with the threads of the bolt or the nut.

When manufacturing this lock nut, it is difficult to achieve the correct thickness of solder so that the thread of each one of the two superimposed nuts will lie on the same helix as the thread of the adjacent nut. In fact, the lock nut must be manufactured by threading one of the nuts onto a screw, depositing spots of solder on the nut, then threading a second one of the nuts to engage the spots of solder. Once the solder has solidified, the lock nut can be unthreaded from the screw. This is quite obviously a cumbersome process and not suitable for mass production.

U.S. Pat. No. 2,394,812 also discloses a lock nut comprising a pair of nuts connected by a circular bridge which is adjacent to the threaded aperture of the nuts. This lock nut is manufactured by (i) tapping hexagonal bar stock to a depth required for one and a half nuts; (ii) advancing the bar stock to the length of one nut; (iii) using a circular power saw, making a circumferential cut inwardly from the outside surface of the bar stock at the length of one nut until the cut approaches the thread of the tap; and (iv) cutting the bar stock at the length of one and a half nuts. Disadvantages of this construction are discussed in U.S. Pat. No. 2,394,812 and include that the circular bridge does not shear cleanly and will leave tangs that may injure the bolt threads. The only solution to this problem which is discussed is the use of clean-shearing bar stock. The use of specialized materials is typically more expensive. In addition, this construction requires a greater shearing force or torque, especially if the bridge is too thick. A circular power saw having a high level of accuracy and a very thin blade is required to create a bridge with a suitable thickness.

Canadian patent No. 835,080 discloses a composite fastener comprising upper and lower portions of a rigid plastic material which form a nut body and a sheet metal nut element. The nut body is formed with a cavity for receiving the sheet metal nut element. The nut body and nut element assembly has substantially greater strength than its components, yet is less susceptible to vibrations than a solid metal nut. This fastener does not lock in place.

Embodiments of the present invention provide a lock nut which is easy to manufacture using common machining tools. The structure of the lock nut permits the lock nut to be securely locked in place without the use of excessive force.

### SUMMARY OF THE INVENTION

In accordance with an embodiment of the present invention there is provided a locking nut comprising at least two nut portions and at least one frangible bridging portion. The at least two nut portions are made from a single nut. Each of the at least two nut portions has an outer gripping surface and a centrally disposed threaded aperture for receiving and engaging a screw. The at least one frangible bridging portion is integral with the at least two nut portions and is disposed to a side of the centrally disposed threaded aperture adjacent to the outer gripping surface. The at least two nut portions are disposed on either side of the at least one frangible bridging portion so that the threaded apertures are axially aligned, respective pitches of threads of the threaded apertures are aligned along at least one helical path and a space is defined between opposing faces of the at least two nut portions. By applying torque to one of the at least two nut portions relative to another one of the at least two nut portions, the at least one frangible bridging portion is sheared so that the opposing faces of the at least two nut portions are brought into contact and the at least two nut portions are locked in place.

In accordance with another embodiment of the present invention, there is provided a method of manufacturing a locking nut. The method comprises the steps of (i) providing a nut having an outer gripping surface and a centrally disposed threaded aperture for receiving and engaging a screw and (ii) machining at least one space approximately halfway along a length of the nut to form at least two nut portions on either side of at least one integral frangible bridging portion for connecting the nut portions so that the threaded apertures are axially aligned, the at least one integral frangible bridging portion being disposed to a side of the centrally disposed threaded aperture adjacent to the outer gripping surface.

With this construction of lock nut, frangible bridging portion will shear cleanly without interfering with the thread of the screw. The lock nut is very easy to manufacture and is suitable for mass production.

### BRIEF DESCRIPTION OF THE DRAWINGS

These and other advantages of the invention will become apparent upon reading the following detailed description and upon referring to the drawings in which:

FIG. 1 is a perspective view of an embodiment of a locking nut in accordance with the present invention;

FIG. 2 is a top view of the nut of FIG. 1; and

FIG. 3 is a side view of the nut of FIG. 1.

While the invention will be described in conjunction with the illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENTS

In the following description, similar features in the drawings have been given identical reference numerals where appropriate. All dimensions described herein are intended solely to illustrate an embodiment. These dimensions are not intended to limit the scope of the invention that may depart from these dimensions.

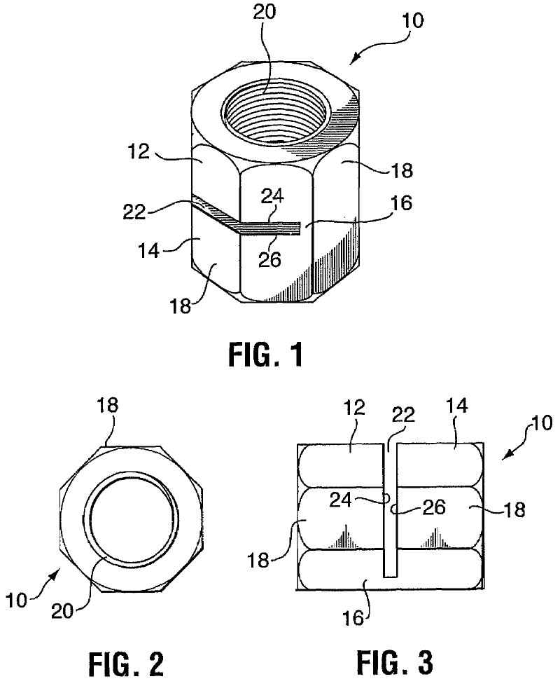

FIG. 1 illustrates a locking nut 10 comprising two nut portions 12 and 14 made from a single nut and a frangible bridging portion 16. Each of the two nut portions 12 and 14 have an outer gripping surface 18, and a centrally disposed threaded aperture 20 for receiving and engaging a screw (not shown). The frangible bridging portion 16.is integral with the two nut portions 12 and 14 and is disposed to a side of the centrally disposed threaded aperture 20 adjacent to the outer gripping surface 18. The two nut portions 12 and 14 are disposed on either side of the frangible bridging portion 16 so that the threaded apertures 20 are axially aligned and a space 22 is defined between opposing faces 24 and 26 of the two nut portions 14 and 16, respectively.

The two nut portions 12 and 14 are threaded onto the screw by applying torque to a one of the two nut portions until a tightened condition is achieved and subsequently applying torque to another one of the two nut portions 12 and 14. By applying torque to one of the two nut portions 12 and 14 relative to another one of the two nut portions 12 and 14, the frangible bridging portion is sheared so that the opposing faces 24 and 26 of the two nut portions are brought into contact and the two nut portions 12 and 14 are locked in place.

The thread of the threaded aperture 20 of a first one of the two nut portions 12 has the same pitch as the thread of the threaded aperture 20 of a second one of the two nut portions 14. The respective pitches of threads of said threaded apertures are aligned along at least one helical path so that the two nut portions 12 and 14 can receive the screw (not shown) without deforming or breaking the frangible bridging portion 16 by applying torque to one of the two nut portions 12.

The space 22 is machined out of a single nut or out of a length of bar stock. This space 22 may be machined approximately halfway along the length of the single nut so that the two nut portions 12 and 14 are of approximately the same size. Of course, the two nut portions 12 and 14 can be of different sizes. Similarly, the frangible bridging portion 16 and the space 22 may be of any suitable size.

The two nut portions 12 and 14 may be made of a single piece of metal.

More than two nut portions 12 and 14 may be provided, separated by a corresponding number of frangible bridging portions 16.

The locking nut 10 or a plurality of these locking nuts 10 may be manufactured by first providing a nut having an outer gripping surface 18 and a centrally disposed threaded aperture 20 for receiving and engaging a screw. The space 22 may then be machined approximately halfway along a length of the nut to form the two nut portions 12 and 14 on either side of the integral frangible bridging portion 16. As explained previously, the frangible bridging portion 16 connects the nut portions 12 and 14 so that the threaded apertures 20 are axially aligned. The frangible bridging portion 16 is disposed to a side of the centrally disposed threaded aperture 20 adjacent to the outer gripping surface 18.

The step of machining is performed by directing a linear cut in from the outer gripping surface 18 perpendicular to the central axis of the threaded apertures 20. This linear cut may be made using commonly available machining tools. Once the cut has been made, the threads of the threaded apertures 20 of the nut portions 12 and 14 should be chased in order to remove any burrs and the like resulting from the linear cut. This can be done by loosely threading a thread chasing tap or the like through the threaded apertures 20 of the nut portions 12 and 14.

Of course, it should be understood that the locking nut 10 or a plurality of these locking nuts 10 may be manufactured from bar stock. The bar stock may be supported using a suitable chuck and the working end of the bar stock may extend beyond the end of the chuck by any suitable length.

The threaded aperture 20 is created by drilling and tapping the hexagonal bar stock to a depth just beyond the depth required for a single nut 10. The end of the bar stock may be machined to form a top face of the nut 10. Using a suitable tool, a linear cut may be made inwardly from the gripping surface 18 of the bar stock at the length of one nut portion (12,14) until the cut approaches the opposite side of the bar stock, thus forming the space 22. Finally, the bar stock may be cut at the length of a single nut 10 (or two nut portions (12, 14)).

The edges of end faces of the nut 10 may be chamfered before or after the nut 10 is cut from the bar stock.

External burrs, for example those produced by the linear cut, may be removed by tumbling the nut 10 or a plurality of nuts 10 in tumbling material (e.g. ball bearings).

Thus, it is apparent that there has been provided in accordance with the invention a locking nut that fully satisfy the objects, aims and advantages set forth above. While the invention has been described in conjunction with illustrated embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

1. A locking nut comprising:
at least two nut portions made from a single nut, each of said at least two nut portions having an outer gripping surface and a centrally disposed threaded aperture for receiving and engaging a screw; and
at least one frangible bridging portion integral with said at least two nut portions and disposed to a side of said centrally disposed threaded aperture adjacent to said outer gripping surface, said at least two nut portions being disposed on either side of said at least one frangible bridging portion so that said threaded apertures are axially aligned, respective pitches of threads of said threaded apertures are aligned along at least one helical path and a space is defined between opposing faces of said at least two nut portions,
wherein by applying torque to one of said at least two nut portions relative to another one of said at least two nut portions, said at least one frangible bridging portion is sheared so that said opposing faces of said at least two nut portions are brought into contact and said at least two nut portions are locked in place.

2. A locking nut according to claim 1, wherein a thread of said threaded aperture of a first one of said at least two nut portions has the same pitch as a thread of said threaded aperture of a second one of said at least two nut portions.

3. A locking nut according to claim 2, wherein said pitches of said threads of said threaded apertures are aligned so that said at least two nut portions can receive said screw without deforming or breaking said frangible bridging portion.

4. A locking nut according to claim 1, wherein said space is machined out of said single nut.

5. A locking nut according to claim 4, wherein said at least two nut portions are of approximately the same size.

6. A locking nut according to claim 1, wherein there are two nut portions separated by a single frangible bridging portion.

7. A locking nut according to claim 1, wherein said at least two nut portions and said frangible bridging portion are made of a single piece of metal.

8. A method of manufacturing a locking nut comprising the steps of:
providing a nut having an outer gripping surface and a centrally disposed threaded aperture for receiving and engaging a screw; and
machining at least one space approximately halfway along a length of said nut to form at least two nut portions on either side of at least one integral frangible bridging portion for connecting said nut portions so that said threaded apertures are axially aligned, said at least one integral frangible bridging portion being disposed to a side of said centrally disposed threaded aperture adjacent to said outer gripping surface.

9. A method of manufacturing according to claim 8, wherein said step of machining is performed by directing a linear cut in from said outer gripping surface perpendicular to an axis of said threaded apertures.

10. A method of manufacturing according to claim 9, further comprising the step of, after said step of machining, chasing threads of said threaded apertures to remove burrs from said threads.

11. A method of manufacturing a locking nut comprising the steps of:
providing hexagonal bar stock having an outer gripping surface;
drilling a centrally disposed aperture in said hexagonal bar stock;
tapping said centrally disposed aperture;
machining at least one space approximately halfway along a length of a nut from an end face of said hexagonal bar stock to form at least two nut portions on either side of at least one integral frangible bridging portion for connecting said nut portions so that said threaded apertures are axially aligned, said at least one integral frangible bridging portion being disposed to a side of said centrally disposed threaded aperture adjacent to said outer gripping surface; and
cutting said hexagonal bar stock at a length of one nut.

12. A method of manufacturing according to claim 11, wherein said step of machining is performed by directing a linear cut in from said outer gripping surface perpendicular to an axis of said threaded apertures.

13. A method of manufacturing according to claim 11, further comprising the step of, after said step of machining, chasing threads of said threaded apertures to remove burrs from said threads.
